(19) United States
(12) Patent Application Publication
(10) Pub. No.: US 2013/0101919 A1
(43) Pub. Date: Apr. 25, 2013

(54) MEMBRANE ELECTRODE ASSEMBLY, FUEL CELL, GAS DETOXIFICATION APPARATUS, AND METHOD FOR PRODUCING MEMBRANE ELECTRODE ASSEMBLY

(71) Applicants: Chihiro Hiraiwa, Osaka-shi (JP); Masatoshi Majima, Itami-shi (JP); Tetsuya Kuwabara, Osaka-shi (JP); Tomoyuki Awazu, Itami-shi (JP)

(72) Inventors: Chihiro Hiraiwa, Osaka-shi (JP); Masatoshi Majima, Itami-shi (JP); Tetsuya Kuwabara, Osaka-shi (JP); Tomoyuki Awazu, Itami-shi (JP)

(73) Assignee: SUMITOMO ELECTRIC INDUSTRIES, LTD., Osaka-shi, Osaka (JP)

(21) Appl. No.: 13/807,379

(22) PCT Filed: Jun. 27, 2011
(86) PCT No.: PCT/JP2011/064645

§ 371 Date: Dec. 28, 2012

(30) Foreign Application Priority Data
Jul. 1, 2010 (JP) 2010-151382
Jul. 21, 2010 (JP) 2010-164108

(51) Int. Cl. B01D 53/32; C25D 15/00; H01M 8/10

(52) U.S. Cl. CPC B01D 53/326; H01M 8/1004; C25D 15/00
USPC 429/482; 204/283; 204/483; 205/112; 427/77

(57) ABSTRACT

Provided are a MEA, a fuel cell, and a gas detoxification apparatus that allow at high efficiency a general electrochemical reaction causing gas decomposition or the like and are excellent in cost efficiency; and a method for producing a MEA. In this MEA 7, a porous base 3, a porous anode 2, an ion-conductive solid electrolyte 1, and a porous cathode 5 are stacked. The anode 2 or the cathode 5 is in contact with a surface of the porous base 3. The porous anode 2 includes a metal deposit body 21 having catalysis for gas decomposition.

### TECHNICAL FIELD

The present invention relates to a membrane electrode assembly (MEA), a fuel cell, a gas detoxification apparatus, and a method for producing a membrane electrode assembly; in particular, to, for example, a membrane electrode assembly, a fuel cell, and a gas detoxification apparatus that are easily produced and allow, for example, highly efficient gas decomposition, and a method for producing a membrane electrode assembly.

### BACKGROUND ART

Although ammonia is an essential compound in agriculture and industry, it is hazardous to humans and hence a large number of methods for decomposing ammonia in water and the air have been disclosed. For example, a method for removing ammonia through decomposition from water containing ammonia at a high concentration has been proposed: aqueous ammonia being sprayed is brought into contact with airflow to separate ammonia into the air and the ammonia is brought into contact with a hypobromous acid solution or sulfuric acid (Patent Literature 1). Another method has also been disclosed: ammonia is separated into the air by the same process as above and the ammonia is incinerated with a catalyst (Patent Literature 2). Another method has also been proposed: ammonia-containing wastewater is decomposed with a catalyst into nitrogen and water (Patent Literature 3).

In general, waste gas from semiconductor fabrication equipment contains ammonia, hydrogen, and the like. To completely remove the odor of ammonia, the amount of ammonia needs to be reduced to the ppm order. For this purpose, a method has been commonly used in which waste gas to be released from semiconductor fabrication equipment is passed through scrubbers so that water containing chemicals absorbs the hazardous gas. On the other hand, to achieve a low running cost without supply of energy, chemicals, or the like, a treatment for waste gas from semiconductor fabrication equipment has been proposed: ammonia is decomposed with a phosphoric acid fuel cell (Patent Literature 4).

### CITATION LIST

### Patent Literature

PTL 1: Japanese Unexamined Patent Application Publication No. 7-31966
PTL 2: Japanese Unexamined Patent Application Publication No. 7-116650
PTL 3: Japanese Unexamined Patent Application Publication No. 11-347535
PTL 4: Japanese Unexamined Patent Application Publication No. 2003-45472

### SUMMARY OF INVENTION

### Technical Problem

As described above, ammonia can be decomposed by, for example, the method of using a chemical solution such as a neutralizing agent (PTL 1), the incineration method (PTL 2), or the method employing a thermal decomposition reaction with a catalyst (PTL 3). However, these methods have problems that they require chemicals and external energy (fuel) and also require periodic replacement of the catalyst, resulting in high running costs. In addition, such an apparatus has a large size and, for example, it may be difficult to additionally install the apparatus in existing equipment in some cases.

As for the apparatus (PTL 4) in which a phosphoric acid fuel cell is used to detoxify ammonia in waste gas from compound semiconductor fabrication, intensive efforts are not made as far as improvement of materials for the purpose of addressing an increase in pressure loss, an increase in electric resistance, and the like, which inhibit enhancement of the detoxification capability. In view of cost efficiency, in the cases of gas decomposition employing a MEA, MEAs that allow highly efficient gas decomposition and are inexpensive are not easily available, which is problematic. A MEA has an anode serving as a fuel electrode, a cathode serving as an air electrode, and a solid electrolyte sandwiched therebetween, and constitutes the core of an electrochemical reaction apparatus. In the fuel electrode, the hydrogen-containing gas molecules such as ammonia are introduced and decomposition of the gas molecules proceeds. The anode is porous in order to achieve a good contact with gas molecules to be decomposed; and the cathode is also porous in order to achieve a good contact with oxygen molecules. The solid electrolyte sandwiched between the electrodes is not porous and serves as a dense wall that does not let gases pass therethrough; it is formed of an ion-conductive material that conducts not electrons but ions.

An object of the present invention is to provide a membrane electrode assembly, a fuel cell, and a gas detoxification apparatus that allow at high efficiency a general electrochemical reaction causing gas decomposition or the like and are excellent in cost efficiency; and a method for producing a membrane electrode assembly.

### Solution to Problem

A membrane electrode assembly (MEA) according to the present invention is used for an electrochemical reaction causing gas decomposition. This MEA includes a porous base and a MEA in which a porous anode, an ion-conductive solid electrolyte, and a porous cathode are stacked. The anode or the cathode is disposed in contact with a surface of the porous base. The porous anode has a porous layer or deposit layer of a metal having catalysis for the gas decomposition.

In the above-described configuration, since the multilayer body of anode/solid electrolyte/cathode is formed on a surface of the porous base, the production is easily performed and the production cost can be readily reduced. The gas decomposition performed in the anode also referred to as a fuel electrode is promoted by the metal having catalysis for the gas decomposition. Accordingly, an electrochemical reaction causing the gas decomposition can be efficiently performed. The porous base need not have ion conductivity or the like and such a porous base having any shape can be relatively easily obtained.

The following configuration may be employed: the porous base is a cylindrical body; the anode is disposed so as to have a cylindrical form in contact with an outer circumferential surface of the cylindrical body; and the solid electrolyte and the cathode are disposed so as to have cylindrical forms on the anode.

Alternatively, the following configuration may be employed: the porous base is a cylindrical body; the cathode is disposed so as to have a cylindrical form in contact with an inner circumferential surface of the cylindrical body; and the solid electrolyte and the anode are disposed so as to have cylindrical forms on an inner-surface side of the cathode.

In such a configuration, a gas requiring high airtightness such as ammonia can be passed inside the cylindrical MEA while contact between oxygen and the cathode disposed on the outer side of the MEA can be easily established.

The cylindrical-body porous base can be produced by a known method employing a material such as calcia stabilized zirconia (CSZ) or silica (SiO₂).

Whether the MEA is disposed on the outer-surface side or the inner-surface side of the cylindrical-body porous base is preferably determined in view of, for example, the size of gas molecules to be introduced into the anode (mobility in the porous base), the threshold outlet concentration of the gas, the structures of collectors, allowable pressure loss, the diameter of the cylindrical body, or the porosity of a porous body forming the anode.

The metal having catalysis may be composed of at least one selected from the group consisting of Ni, a Ni—Fe system, a Ni—Co system, a Ni—Cu system, a Ni—Cr system, and a Ni—W system.

All these metals are relatively easily available and the anode can be easily produced. Accordingly, while the cost efficiency is ensured, an electrochemical reaction causing gas decomposition can be made to proceed at high efficiency. For example, the Ni—Fe system denotes a Ni—Fe alloy or an Fe—Ni alloy.

The anode may have a thickness of 1 μm or more and 1 mm or less. When such a thin anode is employed, contact between a gas (fuel gas) to be decomposed and the whole anode is facilitated to reduce the time required for movement of ions (oxygen ions or protons). As a result, the efficiency of the electrochemical reaction can be increased. When the thickness of the anode is less than 1 the amount of the anode reaction occurring with respect to area does not reach a sufficient amount. When the thickness is more than 1 mm, the region that does not contribute to the reaction increases and the time for movement of ions also increases.

The following configuration may be employed: the anode has a thickness of 50 μm or less and the anode does not contain any ion-conductive ceramic.

The anode is porous, whereas the solid electrolyte is dense but has irregularities in a surface. The anode and the solid electrolyte have irregularities and partially intermix near the interface therebetween. When the thickness of the anode is made 50 μm or less, the specific gravity of the region near the interface between the anode and the solid electrolyte increases; even when the anode itself does not contain any ion-conductive ceramic, the anode can function. In addition, the time for which ions move through the anode is eliminated, the rate at which gas decomposition proceeds can be increased. In addition, the production cost can be advantageously reduced since ion-conductive ceramics are relatively expensive.

The anode may contain an ion-conductive ceramic. In this case, the gas decomposition can proceed over the whole thickness of the anode.

The solid electrolyte may have a thickness of 0.7 μm or more and 20 μm or less. In this case, the time for which ions move through the solid electrolyte can be decreased so that the rate at which the electrochemical reaction proceeds can be increased. Although heating to a high temperature has been performed to decrease the time for which ions move through the solid electrolyte, the heating temperature can be decreased. As a result, the energy efficiency can be increased; in addition, the requirements in terms of heat resistance are relaxed and inexpensive apparatus materials can be used.

When the solid electrolyte has a thickness of less than 0.7 μm, it is less likely to serve as a dense layer required for preventing gas permeation (leakage); when the thickness is more than 20 μm, the time for which ions move through the solid electrolyte becomes long.

The solid electrolyte may be oxygen-ion conductive or proton conductive.

Although oxygen-ion-conductive solid electrolytes are readily available and relatively excellent in cost efficiency, oxygen ions move at a relatively low speed. On the other hand, as to proton-conductive solid electrolytes, protons move at a high speed and the rate of the electrochemical reaction can be increased; however, the electrolytes are limited to several materials such as barium zirconate and they are expensive.

The anode, the solid electrolyte, and the cathode may be formed by an electrophoretic process or a plating process.

In this case, all of the anode, the solid electrolyte, and the cathode can be accurately formed so as to have small thicknesses. In particular, as to the anode, a metal having high catalysis for gas decomposition can be easily deposited to form a deposit layer or a porous layer whether the metal is a single metal or an alloy. Whether an ion-conductive ceramic powder is dispersed or not can be easily controlled by using a dispersion plating process or the like. Note that the plating process may be electroplating or electroless plating.

A conductor having a form that does not degrade porosity may be disposed on at least one selected from a surface and another surface of the porous base, a surface of the anode on a side opposite to the solid electrolyte, and a surface of the cathode on a side opposite to the solid electrolyte.

In this case, an electrical connection having a low electric resistance is easily established between an electrode and a collector. The conductor having a form that does not degrade porosity may be any conductor having porosity and electrical conductivity: for example, (1) metal mesh sheets (e.g. woven fabrics, nonwoven fabrics, and sheets perforated so as to have fine pores), grid (circumference-generatrix) wires, and generatrix wires; (2) metal paste, silver paste, and the like that become porous by sintering.

A fuel cell according to the present invention includes any one of the above-described membrane electrode assemblies. A gas detoxification apparatus according to the present invention includes any one of the above-described membrane electrode assemblies.

In such a case, in a fuel cell or a gas detoxification apparatus, while cost efficiency can be ensured, an electrochemical reaction at high efficiency can be achieved.

To supply electric power from the fuel cell or the like, a voltage on a predetermined level is required. For this reason, a configuration can be employed where a single membrane electrode assembly that is macroscopically integrated is electrically separated into a plurality of regions so as to be insulated from one another, and the plurality of regions are connected to one another in series through a conductor. As a result, for example, in a fuel cell or the like, the output voltage can be increased to provide a power supply that is practically usable. The “macroscopically integrated” denotes a configuration that is practically handled as a single unit without being separated during the formation of the anode and the like. An example of this configuration is a cylindrical MEA. In the above-described invention, the cylindrical MEA is electrically separated into regions with insulating zones therebetween and the regions are connected to one another in series to thereby increase the output voltage or the like.

A method for producing a MEA according to the present invention is a method for producing a MEA used for an electrochemical reaction causing gas decomposition. This method for producing a MEA includes a step of preparing a porous base; a step of forming a multilayer-body MEA in which a porous anode, a solid electrolyte layer, and a porous cathode are stacked by an electrophoretic process or a plating process; and a step of sintering the porous base on which the MEA has been formed. In the step of forming the multilayer-body MEA, the multilayer-body MEA is formed such that the porous anode or the porous cathode is in contact with a surface of the porous base and the anode is formed so as to include a porous layer or deposit layer of a metal having catalysis for the gas decomposition.

Use of the method allows easy formation of a MEA having high gas-decomposition efficiency on a porous base serving as a skeleton of a MEA, by an electrophoretic process or a plating process. As described above, the plating process may be an electroplating process or an electroless plating process. Such plating processes naturally include a dispersion plating process.

In the electrophoretic process or the plating process, the anode may be formed such that ion-conductive ceramic particles are dispersed in the porous layer or deposit layer composed of Ni or a Ni alloy.

This method allows easy production of a MEA in which the anode reaction occurs over the whole thickness from a region near the interface with the solid electrolyte to the surface of the anode.

In the electrophoretic process or the plating process, the anode may be formed such that the porous layer or deposit layer composed of Ni or a Ni alloy does not contain any ion-conductive ceramic particles.

This method allows occurrence of the anode reaction in a region near the interface between the solid electrolyte and the anode. The movement of ions participating in the anode reaction in the anode is not substantially required and hence the rate at which the electrochemical reaction proceeds can be increased.

The porous base may be formed as a cylindrical body; the anode may be formed so as to have a cylindrical form in contact with an outer circumferential surface of the cylindrical body, and a solid electrolyte and the cathode may be subsequently sequentially formed so as to have cylindrical forms on an outer-surface side of the anode.

Alternatively, the porous base may be formed as a cylindrical body; the cathode may be formed so as to have a cylindrical form in contact with an inner circumferential surface of the cylindrical body, and a solid electrolyte and the anode may be subsequently sequentially formed so as to have cylindrical forms on an inner-surface side of the cathode.

In such a case, a cylindrical MEA can be easily produced. The cylindrical MEA can be disposed on the inner-surface side or outer-surface side of the cylindrical-body porous base such that, in each case, the anode is disposed on the inner-surface side of the cylindrical MEA and the cathode is disposed on the outer-surface side of the cylindrical MEA. As described above, whether the cylindrical MEA is disposed on the inner-surface side or outer-surface side of the cylindrical-body porous base may be determined in view of, for example, the structures of collectors, allowable pressure loss, the diameter of the cylindrical body, or the porosity of a porous body forming the anode.

### Advantageous Effects of Invention

In a MEA and the like according to the present invention, a general electrochemical reaction causing gas decomposition or the like can be made to proceed at high efficiency and the cost efficiency can be enhanced.

### BRIEF DESCRIPTION OF DRAWINGS

FIG. 1 illustrates a gas detoxification apparatus including a MEA according to a first embodiment of the present invention.

FIG. 2 is an enlarged view of a portion A in FIG. 1.

FIG. 3A illustrates a dispersion plating process (electroplating process) for producing the MEA according to the present embodiment.

FIG. 3B illustrates a mechanism by which, in a dispersion plating process (electroplating process) for producing the MEA according to the present embodiment, ceramic particles are dispersed in a plating solution by using a surfactant.

FIG. 4 illustrates a MEA according to a second embodiment of the present invention.

FIG. 5 is an enlarged view of a portion A in FIG. 4.

FIG. 6 illustrates the interface of anode/solid electrolyte in a MEA according to a modification of the second embodiment, the modification also serving as an embodiment of the present invention.

FIG. 7 illustrates a MEA according to a third embodiment of the present invention.

FIG. 8 is an enlarged view of a portion A in FIG. 7.

FIG. 9 illustrates a gas detoxification (decomposition) apparatus including a MEA according to a fourth embodiment of the present invention.

FIG. 10 is a sectional view taken along line X-X in FIG. 9.

FIG. 11A illustrates a metal mesh sheet having pores formed by perforation.

FIG. 11B illustrates a metal mesh sheet that is a metal woven fabric.

FIG. 12 illustrates a fuel cell system according to the present invention.

### DESCRIPTION OF EMBODIMENTS

### First Embodiment

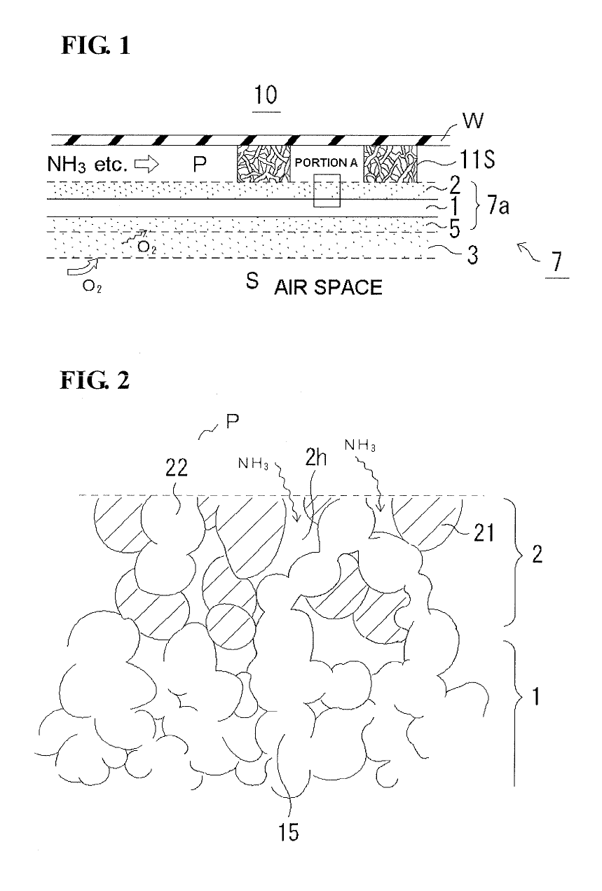

FIG. 1 illustrates a gas detoxification apparatus 10 including a MEA 7 according to a first embodiment of the present invention. In this gas detoxification apparatus, plate-shaped MEAs are repeatedly stacked. The multilayer configuration of a single unit is as follows.

(air space S/porous base 3/cathode 5/solid electrolyte 1/anode 2/passage P/partition wall W)

A gas to be decomposed or a fuel gas, such as ammonia, flows through the passage P between the partition wall W and the anode 2. Since a porous plated body 11s for preventing such a gas from passing without being treated is disposed, the gas does not pass without being treated but comes into contact with the anode 2 and is decomposed (anode reaction). The anode 2 may also be referred to as a fuel electrode. The porous plated body 11s prevents the gas from passing without being treated and also constitutes an anode collector. The anode collector is commonly constituted by a plurality of members and the porous plated body 11s serves as one of the members.

The cathode 5, which may also be referred to as an air electrode, faces the air space S and comes into contact with the air to decompose oxygen molecules in the air (cathode reaction).

As a result of electrochemical reactions in the two electrodes (anode and cathode), ions are generated in one of the electrodes and electrons are generated in the other electrode. The ions pass through the solid electrolyte 1 and the electrons pass through an external circuit (not shown) in which a load is interposed, to reach the opposite electrodes and participate in the anode and cathode reactions.

The porous base 3 may be formed of a porous ceramic such as calcia stabilized zirconia (CSZ) or silica (SiO₂).

FIG. 2 is an enlarged view of a portion A in FIG. 1. An example will be described in which ammonia is decomposed and the solid electrolyte 1 is oxygen-ion conductive. In FIG. 2, the solid electrolyte 1 is dense (non-porous) so as not to pass gases therethrough; the solid electrolyte 1 passes oxygen ions therethrough but does not pass electrons therethrough. Ammonia NH₃ flowing through the passage P reacts with oxygen ions having been generated in the cathode 5 and having passed through the solid electrolyte 1, to cause the following electrochemical reaction.

2NH₃+3O²⁻→N₂+3H₂O+6e⁻ (Anode reaction)

Specifically, a portion of ammonia reacts: 2NH₃→N₂+3H₂. These 3H₂ react with the oxygen ions 3O²⁻ to generate 3H₂O. In this decomposition of ammonia, a deposit body (layer) 21 or porous body (layer) 21 of a metal having catalysis promotes the decomposition. The anode 2 contains, in addition to the deposit body 21 of a metal having catalysis, oxygen-ion-conductive ceramic particles 22 and guides oxygen ions to the anode-reaction sites. Ammonia moves through pores 2h to the decomposition sites in the anode 2.

As a result of the anode reaction, while an outlet concentration described below can be decreased to the predetermined level or less, the ammonia decomposition process can be made at least not to become the bottleneck (process that limits the rate) of the overall electrochemical reaction. The anode 2 is made to have a thickness of 1 μm or more and 1 mm or less, in particular, may have a small thickness of 1 μm or more and 50 μm or less, and may have a very small thickness of 25 μm or less.

The air, in particular, oxygen gas is passed through the space S and introduced into the cathode 5. Oxygen ions dissociated from oxygen molecules in the cathode 5 are sent to the solid electrolyte 1 toward the anode 2. The cathode reaction is as follows.

O₂+4e⁻→2O²⁻ (Cathode reaction)

As a result of the electrochemical reaction, electric power is generated; a potential difference is generated between the anode 2 and the cathode 5; current flows from a cathode collector to an anode collector. When a load, such as a heater for heating the gas detoxification apparatus 10, is connected between the cathode collector and the anode collector, electric power for the heater can be supplied. This supply of electric power to the heater may be a partial supply. Rather, in most cases, the amount of supply from the self power generation is equal to or lower than half of the overall electric power required for the heater.

### <Anode>

An ammonia-containing gaseous fluid is introduced into the anode 2 and flows through the pores 2h. The anode 2 is a sinter mainly composed of a catalyst, that is, the metal deposit body 21 and the oxygen-ion-conductive ceramic 22. Here, the metal deposit body 21 is preferably formed of at least one selected from the group consisting of Ni, a Ni—Fe system, a Ni—Co system, a Ni—Cu system, a Ni—Cr system, and a Ni—W system.

Examples of the oxygen-ion-conductive ceramic 22 include scandium stabilized zirconia (SSZ), yttrium stabilized zirconia (YSZ), samarium stabilized ceria (SDC), lanthanum gallate (LSGM), and gadolia stabilized ceria (GDC).

In addition to the catalysis, in the anode, oxygen ions are used in the decomposition reaction. Specifically, the decomposition is performed in the electrochemical reaction. In the anode reaction 2NH₃+3O²⁻→N₂+3H₂O+6e⁻, oxygen ions contribute to a considerable increase in the decomposition rate of ammonia.

In the anode reaction, free electrons e⁻ are generated. When electrons e⁻ remain in the anode 2, the occurrence of the anode reaction is inhibited. The metal deposit body 21 serves as a good conductor. Electrons e⁻ smoothly flow through the metal deposit body 21. Accordingly, electrons e⁻ do not remain in the anode 2 and pass through the metal deposit body 21 and circulated through an external circuit. The metal deposit 21 considerably facilitates passage of electrons C. In summary, features in an embodiment of the present invention are the following (e1), (e2), and (e3) in the anode.

(e1) promotion of decomposition reaction by metal deposit body 21 (high catalysis)
(e2) promotion of decomposition by oxygen ions (promotion of decomposition in electrochemical reaction)
(e3) establishment of conduction of electrons through metal deposit body 21 (high electron conductivity)

These (e1), (e2), and (e3) considerably promote the anode reaction.

By simply increasing the temperature and contacting with the catalyst a gas to be decomposed, decomposition of this gas proceeds. However, as described above, in a component constituting a fuel cell, oxygen ions supplied from the cathode 5 and through the ion-conductive solid electrolyte 1 are used in the reaction and the resultant electrons are circulated through an external circuit; thus, the rate of the decomposition reaction is considerably increased. A big feature of the present invention is the functions (e1), (e2), and (e3) above and a configuration providing these functions.

In the above description, the case where the solid electrolyte 1 is oxygen-ion conductive is described. Alternatively, the solid electrolyte 1 may be proton (H⁺)-conductive. In this case, the ion-conductive ceramic 22 in the anode 2 is a proton-conductive ceramic, for example, preferably barium zirconate.

(In the case of using metal deposit body and ion-conductive ceramic): When the oxygen-ion-conductive metal oxide (ceramic) in the anode 2 is SSZ, a SSZ raw-material powder preferably has an average particle diameter of about 0.5 μm to about 50 μm. The mol ratio of the metal deposit body 21 to SSZ 22 is in the range of 0.1 to 10. The production method of the MEA 7 by a dispersion plating process or the like will be described below.

As to conditions for co-sintering of the MEA 7 including the porous base 3 and a multilayer-body MEA body 7a, for example, the MEA 7 is held in the air atmosphere at a temperature in the range of 1000° C. to 1600° C. for 30 to 180 minutes.

(In the case of using metal deposit body only): The metal deposit body 21 is formed by a dispersion plating process or the like described below. In the case of a Ni—Fe system alloy, as to the composition, for example, the Ni content is preferably about 60 at %.

In the co-sintering, the same thermal pattern as in the above case is applied.

### <Cathode>

In the cathode 5, the air, in particular, oxygen molecules are introduced. The cathode 5 is a sinter mainly composed of an oxygen-ion-conductive ceramic. In this case, preferred examples of the oxygen-ion-conductive ceramic include lanthanum strontium manganite (LSM), lanthanum strontium cobaltite (LSC), and samarium strontium cobaltite (SSC).

The cathode 5 is preferably formed so as to contain silver particles, which have high catalysis for oxygen. Ag particles exhibit catalysis that considerably promotes the cathode reaction: O₂+4e⁻→2O²⁻. As a result, the cathode reaction can proceed at a very high rate. The Ag particles preferably have an average diameter of 10 nm to 100 nm.

In the above description, the case where the solid electrolyte 1 is oxygen-ion conductive is described. Alternatively, the solid electrolyte 1 may be proton (H⁺)-conductive. In this case, the ion-conductive ceramic in the cathode 5 is a proton-conductive ceramic, for example, preferably barium zirconate.

In the cathode 5, SSZ having an average diameter of about 0.5 μm to about 50 μm is preferably used. Sintering conditions are holding in the air atmosphere at a temperature in the range of 1000° C. to 1600° C. for about 30 to about 180 minutes.

### <Solid Electrolyte>

Although the electrolyte 1 may be a solid oxide, molten carbonate, phosphoric acid, a solid polymer, or the like, the solid oxide is preferred because it can be used in a small size and easily handled. Preferred examples of the solid oxide 1 include oxygen-ion-conductive oxides such as SSZ, YSZ, SDC, LSGM, and GDC.

In another desirable embodiment according to the present invention, for example, the solid electrolyte 1 is composed of barium zirconate (BaZrO₃) and a reaction is caused in which protons are generated in the anode 2 and moved through the solid electrolyte 1 to the cathode 5. When a proton-conductive solid electrolyte 1 is used, for example, in the case of decomposing ammonia, ammonia is decomposed in the anode 2 to generate protons, nitrogen molecules, and electrons; the protons are moved through the solid electrolyte 1 to the cathode 5; and, in the cathode 5, the protons react with oxygen to generate water (H₂O). Since protons are smaller than oxygen ions, they move through the solid electrolyte at a higher speed than oxygen ions. Accordingly, while the heating temperature can be decreased, the decomposition capacity on the practical level can be achieved. In addition, the solid electrolyte 1 can be easily formed so as to have a thickness providing a sufficient strength.

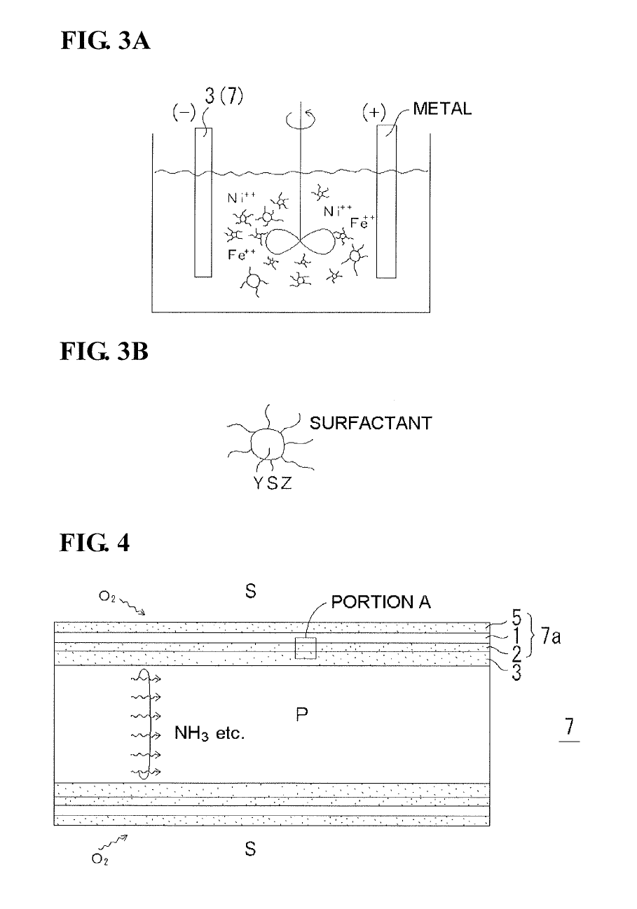

FIG. 3A illustrates a dispersion plating process (electroplating process) for producing the anode 2 of the MEA 7 according to the present embodiment. In a plating solution, ions of a material and ceramic particles to be deposited on the negative electrode are dispersed. In the case of dispersing ceramic particles, a surfactant may be used so that surfactant molecules adhere to the surfaces of the ceramic particles to thereby disperse the ceramic particles in the solution (refer to FIG. 3B). The plating bath is desirably stirred to maintain homogeneity.

In the case of forming the multilayer in the MEA body portion 7a in FIG. 1, a work is plated in a plating bath for the cathode 5. The electrolyte such as LSM is dispersed and a plated layer is formed on the work. To form a porous cathode, the plated layer is preferably formed under conditions of a high voltage and a low current for causing burnt deposit.

After the plated layer of the cathode 5 is formed, the plated layer of the solid electrolyte 1 is formed. Similarly, the solid electrolyte 1 is formed by dispersion plating, though the ceramic material is different. Note that voltage and current are selected so that the solid electrolyte 1 is formed to be non-porous and become a dense layer after sintering.

After the plated layer of the solid electrolyte 1 is formed, the plated layer of the anode 2 is formed thereon.

As to the anode 2, in the present embodiment, a solid electrolyte such as YSZ particles are dispersed and metal ions such as Ni ions and Fe ions are dissolved (refer to FIG. 3A). As the positive electrode, a plate, rod, or wire of a Ni—Fe alloy serving as a source of the metal ions is disposed. As the negative electrode, a member to be plated (work), that is, porous base 3/cathode 5/solid electrolyte 1 is disposed; a plated layer composed of the metal Ni—Fe deposit body 21 and the ceramic particles 22 is formed on the solid electrolyte 1. As described above, the metal plate serving as a source is preferably, for example, a Ni—Fe alloy having a Ni content of 60 at %.

After that, porous base 3/plated layer of cathode/plated layer of solid electrolyte/plated layer of anode is co-sintered. As described above, co-sintering conditions are, for example, holding in the air atmosphere at a temperature in the range of 1000° C. to 1600° C. for about 30 to about 180 minutes.

Instead of the electroplating process illustrated in FIG. 3, an electroless plating process may be used to form plated layers of the MEA body portion 7a. In particular, the plated layer of the solid electrolyte 1 is preferably formed by an electroplating process, whereas the anode 2 and the cathode 5 are preferably formed by an electroless plating process. Since a plated layer grows at a low rate in an electroless plating process, a porous layer can be relatively easily formed.

When the plated layer of the anode 2 is formed by electroless plating, a catalyst such as palladium is preferably disposed as an undercoat. The catalyst for the undercoating is commercially available under a name such as CRP catalyst (Okuno Chemical Industries Co., Ltd.). Such an undercoated work is immersed and held in an electroless solution in which YSZ is dispersed and Ni ions and Fe ions are dissolved. Depending on the holding time, the electroless plated layer of the anode 2 grows. Unless the holding time is long in the electroless plating process, the electroless plated layer is porous. This is also the case for a cathode plated layer formed of ceramic particles only and an anode plated layer formed of metal and ceramic particles. In particular, in the case of a small thickness, porosity is easily ensured.

Sintering may cause shrinkage. However, when a plated layer is formed so as to be porous in consideration of the shrinkage, the layer having been sintered still remains porous.

### Second Embodiment

FIG. 4 illustrates a MEA 7 according to a second embodiment of the present invention. This MEA 7 is a cylindrical body. For reference purposes, the flow of ammonia serving as an example of a gas to be decomposed and the flow of oxygen molecules are illustrated. Ammonia or the like comes into contact with an anode 2 disposed on the inner-surface side of the cylindrical MEA 7. Oxygen or the air comes into contact with a cathode 5 disposed on the outer-surface side of the cylindrical MEA. The multilayer configuration of the cylindrical body is as follows.

(cylindrical porous base 3/cylindrical porous anode 2/cylindrical solid electrolyte 1/cylindrical porous cathode 5)

The anode 2 is disposed on the inner side of a MEA body portion 7a. Since leakage of a gas to be detoxified such as ammonia should be avoided as much as possible, the gas is passed inside the cylinder for easily achieving airtightness. On the other hand, the cathode 5 is positioned on the outer side to easily come into contact with the air.

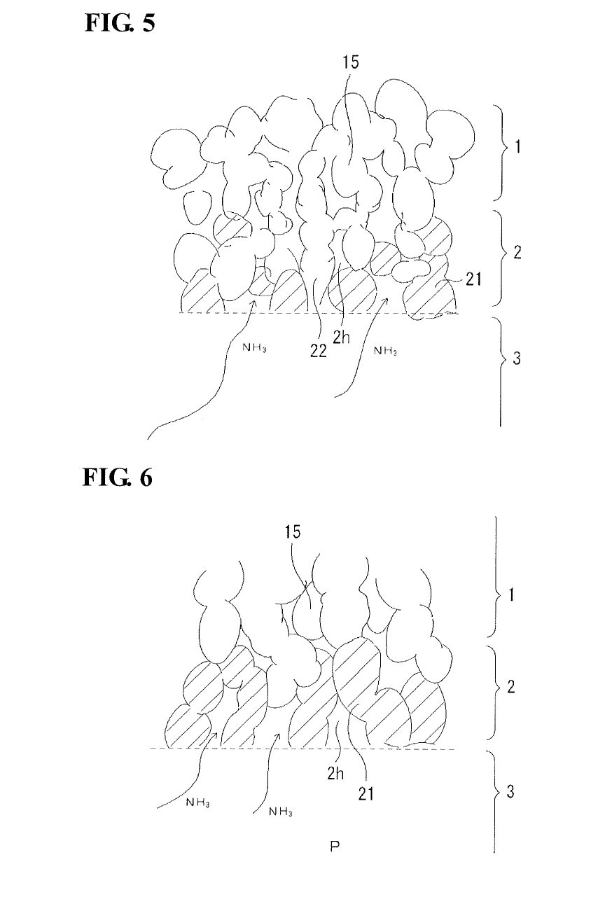

FIG. 5 is an enlarged view of a portion A in FIG. 4. A hydrogen source gas such as ammonia passes through a passage P (refer to FIG. 4) and the porous base 3 to the anode 2. In the anode 2, a metal deposit body 21 and an ion-conductive ceramic 22 are disposed so as to surround pores 2h.

The anode reaction in the anode 2 and the cathode reaction in the cathode 5 are the same as those in the first embodiment.

FIG. 6 illustrates a modification of the present embodiment, the modification also serving as an embodiment of the present invention. This modification has a feature that the anode 2 is formed of the metal deposit body 21 only and does not contain any ion-conductive ceramic.

In general, the interface between the solid electrolyte 1 and the anode 2 is not flat and has an irregular and complex structure. Accordingly, after the co-sintering, an ion-conductive ceramic 15 of the solid electrolyte 1 enters the anode 2 formed of the metal deposit body 21 only. Stated another way, when the anode 2 has a small thickness, in a relatively large proportion of the thickness of the anode 2, the ion-conductive ceramic 15 of the solid electrolyte 1 and the metal deposit body 21 intermix. Thus, when the anode 2 has a small thickness, it can sufficiently function as an anode even though the anode 2 is formed so as not to contain any ion-conductive ceramic such as YSZ.

By reducing the thickness of the anode 2, the rate at which the electrochemical reaction proceeds can be increased to increase the efficiency.

In addition, reduction of the usage amounts of ion-conductive ceramics such as YSZ, which are relatively expensive, can result in an increase in cost efficiency.

When the anode 2 is formed of the metal deposit layer 21 only and it can function as an anode due to intermixing with the irregularly-shaped solid electrolyte 15 in the surface of the solid electrolyte 1, the anode 2 preferably has a thickness of 5 μm or more and 50 μm or less, more preferably 5 μm or more and 25 μm or less.

In the formation of the anode 2 illustrated in FIG. 6, ion-conductive ceramic particles are not dispersed in the plating solution.

### Third Embodiment

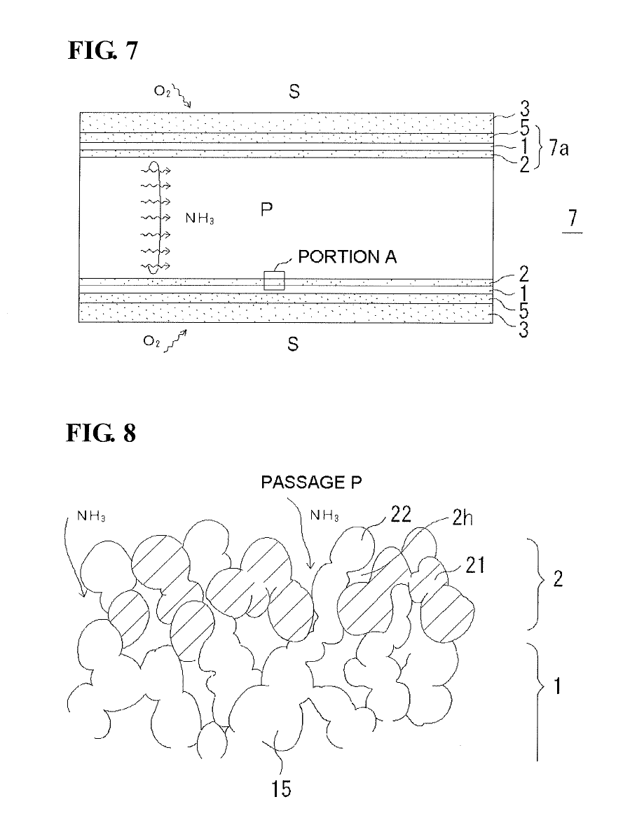

FIG. 7 illustrates a MEA 7 according to a third embodiment of the present invention. This MEA 7 is also a cylindrical body. However, unlike the second embodiment, the MEA body portion 7a is formed on the inner-surface side of the cylindrical porous base 3. In the second embodiment, the MEA body portion 7a is formed on the outer-surface side of the cylindrical porous base 3. The MEA 7 in FIG. 7 has the following multilayer configuration starting on the inner-surface side.

(cylindrical porous anode 2/cylindrical solid electrolyte 1/cylindrical porous cathode 5/cylindrical porous base 3)

The anode reaction and the cathode reaction are the same as the electrochemical reactions described in the first embodiment. However, in the present embodiment, a gas to be detoxified or a fuel gas, such as ammonia, does not pass through the porous base 3 but directly comes into contact with the anode 2. Thus, when a target outlet concentration on the ppm order is defined as in a gas detoxification apparatus, the MEA 7 of the present embodiment is desirably used. This is because, in the MEA 7 having the form according to the second embodiment, a gas to be detoxified may remain in the porous base 3 and detoxification to a very low concentration may takes a long time. In contrast, in the present embodiment, (T1) a gas to be detoxified does not remain in the porous base 3 and hence detoxification to a very low concentration can be achieved in a short time.

FIG. 8 is an enlarged view of a portion A in FIG. 7. A gas to be detoxified such as ammonia in the passage P can directly come into contact with the anode. When the gas moves through the porous base 3 to the anode 2, the gas may stagnate in the porous base 3, which may cause degradation of gas treatment performance. In the present embodiment, (T2) the gas directly comes into contact with the anode 2 without, for example, stagnation of the gas. Accordingly, stagnation of the gas does not cause degradation of gas treatment performance.

The production of the MEA 7 basically starts from the porous base 3. When a cylindrical-body porous base 3 is used as a work and subjected to dispersion electroplating or dispersion electroless plating, a plating solution is made to smoothly flow inside the cylindrical porous base 3 and to circulate so that a plated layer is uniformly formed inside the cylindrical porous base 3. For this reason, for example, the following technique is preferably employed: a stirrer is positioned laterally (horizontally) as in screws of ships so that the plating solution is fed to the inner surface of the cylindrical porous base 3 positioned horizontally.

As in the modification of the second embodiment (refer to FIG. 6), the anode 2 illustrated in FIG. 8 may also be formed of the metal deposit body 21 only without containing any ion-conductive ceramic.

### Fourth Embodiment

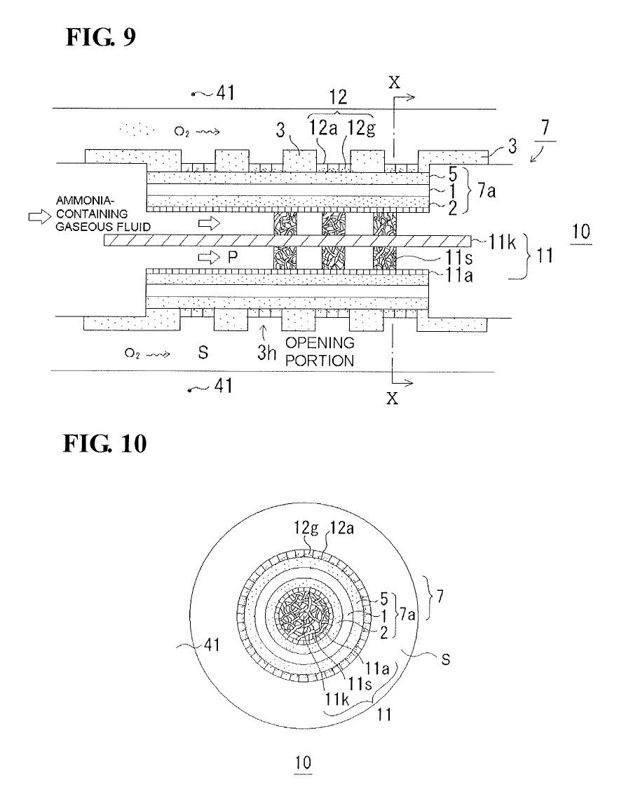

FIG. 9 illustrates a gas detoxification apparatus 10 including a MEA 7 according to a fourth embodiment of the present invention. FIG. 10 is a sectional view taken along line X-X in FIG. 9. In the present embodiment, in the MEA 7, a porous base 3 has relatively large opening portions 3h and, in these opening portions 3h, metal mesh sheets 12a that do not degrade porosity of the cathode 5 are disposed. The metal mesh sheets 12a and silver paste 12g that has been sintered under conditions suitable for the silver paste are fixed to the cathode 5. In FIG. 9, upper and lower opening portions 2h appear to be at the same positions and continuously formed; however, actually, the opening portions 3h are discontinuously disposed and have an opening diameter that is equal to or less than a fraction of the circumference. The metal mesh sheets 12a disposed in the opening portions 3h of the porous base 3 so as to be in contact with a surface of the cathode 5 (the surface being opposite to a solid electrolyte 1) serve as a main part of a cathode collector 12. The metal mesh sheets 12a limited to be in the opening portions 3h are integrated with an appropriate conductor or wiring (not shown) to function as the cathode collector 12.

A metal mesh sheet 11a that does not degrade porosity of an anode 2 is also disposed on a surface of the anode 2. The metal mesh sheet 11a disposed on the anode surface constitutes a part of an anode collector 11.

The metal mesh sheets 11a and 12a are preferably formed of, for example, Ni, a Ni—Fe system, a Ni—Co system, a Ni—Cu system, a Ni—Cr system, or a Ni—W system. For example, a nonwoven fabric of such a metal or a metal nonwoven fabric including a plated layer of such a metal may be used.

The anode collector 11 has the following configuration: anode 2/metal mesh sheet 11a/porous plated body 11s for preventing gas from passing without being treated/central conductive rod 11k. A hydrogen-containing reducing gas such as ammonia is introduced into the anode 2.

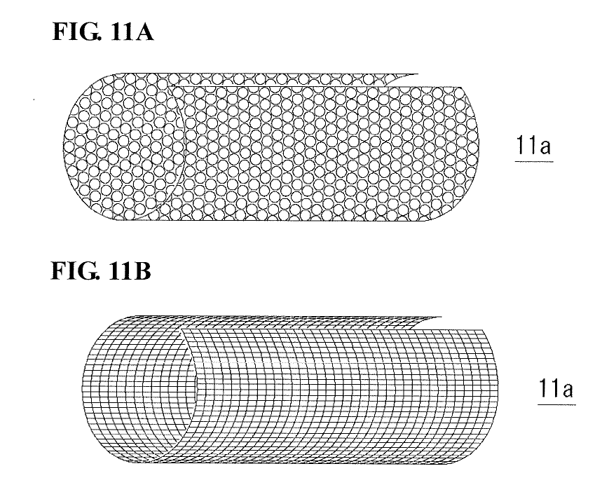

FIGS. 11A and 11B illustrate the metal mesh sheets 11a. As for FIG. 11A, a single-phase metal sheet is perforated to form the mesh structure. FIG. 11B illustrates a metal woven fabric. The mesh size is exaggeratedly illustrated. The metal mesh sheet 11a may be selected from the sheets illustrated in FIGS. 11A and 11A. When the metal mesh sheet 11a is formed of Ni, a Ni—Fe system, a Ni—Co system, a Ni—Cu system, a Ni—Cr system, or a Ni—W system, the metal mesh sheet 11a exhibits catalysis as with the metal deposit body 21 in the anode 2 to thereby promote decomposition of ammonia or the like.

In the case of Ni, a Ni—Fe system, a Ni—Co system, or a Ni—Cu system, reduction bonding of the metal mesh sheet 11a to the anode 2 can be readily achieved. Specifically, reduction bonding can be achieved without considerably decreasing oxygen partial pressure.

The metal mesh sheets 12a constituting the cathode collector 12 are preferably woven fabrics formed of a Ni—Cr system or a Ni—W system or metal woven fabrics including plated layers of such a metal. This is because a Ni—Cr system or Ni—W system metal has high oxidation resistance though oxygen is introduced into the cathode 5 and oxidation tends to proceed in high-temperature environments. Use of such metal mesh sheets 12a can enhance durability of the cathode collector 12. The metal mesh sheets 12a constituting the cathode collector 12 are formed by partially cutting the metal mesh sheets 11a for the anode collector 11 illustrated in FIGS. 11A and 11B so as to correspond to the shape of the opening portions 3h.

The silver paste remains as silver particles 12g. The silver particles 12g serve as a strong catalyst that promotes decomposition of oxygen molecules. Accordingly, the rates at which oxidation reactions of surrounding materials proceed can be substantially considerably decreased. As a result, the effect of substantially decreasing the concentration of oxygen molecules can be exerted to further enhance durability, though the metal mesh sheets 12a are formed of such an oxidation resistant metal and have oxidation resistance.

In addition, since silver is a very good conductor and the electric resistance of the cathode collector 12 can be decreased.

The production method of the MEA 7 illustrated in FIG. 9 is basically the same as the production method of the MEA in the first embodiment or the like. Differences are that the opening portions 3h are formed and the cathode collector 12 and the anode collector 11 are disposed. Points during the production are as follows.

(1) The opening portions 3h are formed in the porous base 3 before a dispersion plating treatment is performed.
(2) During the dispersion plating treatment, detachable pad members are placed in the opening portions 3h so that the cathode 5 corresponding to the opening portions 3h is also formed on the same plane as the cylindrical surface of non-opening portions of the porous base 3.
(3) The porous base 3 with opening portions 3h/cathode 3/solid electrolyte 1/anode 2 is formed by the dispersion plating treatment (refer to FIGS. 3A and 3B). The pad members are detached. Co-sintering is then performed before the metal mesh sheets 11a and 12a are placed. Conditions for the co-sintering are described above.
(4) Anode collector 11:

To an intermediate product obtained by the co-sintering, the metal mesh sheet 11a is bonded so as to be in contact with the anode 2 by reduction bonding. As to conditions of the reduction bonding, in the case of using both an inert gas and a reducing gas, a nitrogen gas serving as a base and containing a small amount of a gas such as ammonia is preferably made to flow. For example, (3% NH₃+N₂) may be used. Such non-oxidizing gases are used and leakage is checked to achieve a low oxygen partial pressure of about 1E-15 atm. As to the temperature, heating is performed to achieve a temperature at which diffusion sufficiently occurs, for example, about 950° C. When a sufficiently low oxygen partial pressure is achieved, reduction bonding naturally proceeds at 950° C. The holding time at 950° C. is preferably, for example, 20 minutes. As a result, an electrode connection structure allowing a good contact between the anode 2 and a gas to be decomposed and having a low electric resistance can be obtained.

The porous plated body 11s wound around the central conductive rod 11k is preferably Celmet (registered trademark: Sumitomo Electric Industries, Ltd.), which can be selected so as to have a high porosity. The sheet-shaped Celmet 11s is wound around the central conductive rod 11k and inserted so as to be surrounded by the metal mesh sheet 11a. At this time, paste of a metal such as Ni is preferably sufficiently applied to the outer circumferential surface of the Celmet 11s or the inner circumferential surface of the metal mesh sheet 11a. In the state where the Celmet 11s has been inserted, reduction bonding is performed again.

The reduction bonding between the anode 2 and the metal mesh sheet 11a and the reduction bonding between the metal mesh sheet 11a and the porous plated body 11s or Celmet 11s may be simultaneously performed.

(5) Cathode collector 11:

The metal mesh sheets 12a formed so as to correspond to the shape of the opening portions 3h are prepared. The metal mesh sheets 12a are fixed so as to be in contact with the cathode 5 by using the silver paste 12g and other fasteners. According to sintering conditions for the silver paste 12g, for example, sintering is preferably performed at 900° C. in a nitrogen atmosphere.

The metal mesh sheets 12a disposed separately in the opening portions 3h can be connected with a conductor or wiring (not shown) to constitute an integrated cathode collector.

### Fifth Embodiment

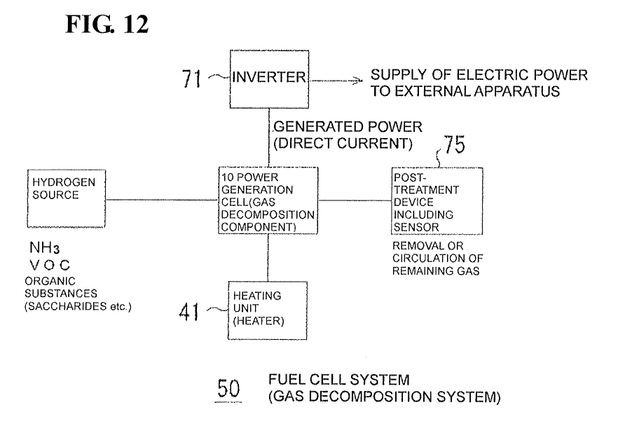

FIG. 12 illustrates a gas decomposition system functioning as a fuel cell according to a fifth embodiment of the present invention. In this fuel cell system 50, a hydrogen source that is hydrogen-containing molecules such as ammonia, toluene, and xylene is supplied from a hydrogen source and decomposed in a power generation cell 10 or a gas decomposition component 10. The MEA (not shown) of the gas decomposition component 10 is any one of the MEAs described in the first to fourth embodiments. The electrochemical reaction of gas decomposition results in generation of electric power. A portion of the electric power is used for a heating unit (heater) 41 for enhancing the gas decomposition performance or power generation performance. The remainder of the electric power is converted to an electric-power form compatible with an external apparatus, for example, by alternating-current/direct-current conversion with an inverter 71 and boosting of the voltage. Thus, the fuel cell system of the present embodiment can employ various hydrogen sources including organic substances such as saccharides and can be used as a power supply for electronic devices such as personal computers (PCs) and mobile terminals or a power supply for electric devices consuming higher electric power.

A gaseous fluid discharged from the power generation cell 10 or the gas decomposition component 10 after decomposition is measured with a post-treatment device (including sensor) 75 in terms of concentrations of remaining components and treated to ensure safety. In this case, depending on the concentrations of remaining components, the gaseous fluid can be returned for circulation.

In the fuel cell system 50, it is not necessary to make the concentration of the gas component be very low as in the case for gas detoxification; by causing the electrochemical reaction for decomposition at a high gas-component concentration, high power-generation performance can be achieved.

### (Another Electrochemical Reaction)

Table I describes examples of other gas decomposition reactions to which a MEA or the like according to the present invention can be applied. A gas decomposition reaction R1 is an ammonia/oxygen decomposition reaction described in the first embodiment and the like. In addition, a catalyst and an electrode according to the present invention can be applied to all the gas decomposition reactions R2 to R20: specifically, ammonia/water, ammonia/NOx, hydrogen/oxygen/, ammonia/carbon dioxide, volatile organic compounds (VOC)/oxygen, VOC/NOx, water/NOx, and the like.

TABLE I

| | Item | | | | |
|---|---|---|---|---|---|
| | Gas introduced | Moving | Gas introduced | | Electrochemical |
| Number | into anode | ion | into cathode | Mode | reaction |
| R1 | NH₃ | O²⁻ | O₂ | Power generation | Oxidation |
| R2 | NH₃ | O²⁻ | H₂O | Power generation | Oxidation |
| R3 | NH₃ | O²⁻ | NO₂, NO | Power generation | Oxidation |
| R4 | H₂ | O²⁻ | O₂ | Power generation | Oxidation |
| R5 | NH₃ | O²⁻ | CO₂ | Electrolysis | Oxidation |
| | | | | (supply of electric power) | |
| R6 | VOC such as CH₄ | O²⁻ | O₂ | Power generation | Oxidation |
| R7 | VOC such as CH₄ | O²⁻ | NO₂, NO | Electrolysis | Oxidation |
| | | | | (supply of electric power) | |
| R8 | H₂O | O²⁻ | NO₂, NO | Electrolysis | Oxidation |
| | | | | (supply of electric power) | |
| R20 | Cyan-based hydrogen | O²⁻ | O₂ | Low power generation | Oxidation |
| | such as HCN | | | | |

Table I merely describes several examples of a large number of electrochemical reactions. A catalyst and an electrode according to the present invention are also applicable to a large number of other reactions. For example, the reaction examples in Table I are limited to examples in which oxygen-ion-conductive solid electrolytes are employed. However, as described above, reaction examples in which proton (H⁺)-conductive solid electrolytes are employed are also major embodiments of the present invention. Even when a proton-conductive solid electrolyte is employed, in the combinations of gases described in Table I, the gas molecules can be finally decomposed, though the ion species passing through the solid electrolyte is proton. For example, in the reaction (R1), in the case of a proton-conductive solid electrolyte, ammonia (NH₃) is decomposed in the anode into nitrogen molecules, protons, and electrons; the protons move through the solid electrolyte to the cathode; the electrons move through the external circuit to the cathode; and, in the cathode, oxygen molecules, the electrons, and the protons generate water molecules. In view of the respect that ammonia is finally combined with oxygen molecules and decomposed, this case is the same as the case where an oxygen-ion solid electrolyte is employed.

The above-described electrochemical reactions are gas decomposition reactions intended for gas detoxification. There are also gas decomposition components whose main purpose is not gas detoxification. A gas decomposition component according to the present invention is also applicable to such electrochemical reaction apparatuses, such as fuel cells.

Embodiments of the present invention have been described so far. However, embodiments of the present invention disclosed above are given by way of illustration, and the scope of the present invention is not limited to these embodiments. The scope of the present invention is indicated by Claims and embraces all the modifications within the meaning and range of equivalency of the Claims.

### INDUSTRIAL APPLICABILITY

In a MEA and the like according to the present invention, a general electrochemical reaction causing gas decomposition or the like can be made to proceed at high efficiency and the cost efficiency can be enhanced. In particular, by forming a porous base as a cylindrical body, the size of a gas treatment apparatus requiring high airtightness can be reduced and the apparatus can be easily installed near an apparatus generating a gas. Accordingly, transfer of a gas having a high concentration through pipes to large gas treatment equipment in conventional cases is no longer required and serious accidents can be prevented even in the case of, for example, an earthquake.

### REFERENCE SIGNS LIST

1 solid electrolyte
2 anode
2h pore in anode
3 porous base
3h opening portion in porous base
5 cathode
7 MEA (membrane electrode assembly)
7a MEA body portion
10 gas decomposition apparatus (component)
11 anode collector
11a metal mesh sheet
11k central conductive rod
11s porous metal body (porous plated body)
12 cathode collector
12a metal mesh sheet
12g silver-paste-coated portion (silver particles)
15 ion-conductive ceramic
21 deposit body or porous body of metal in anode
22 ion-conductive ceramic in anode
41 heater
71 inverter
75 post-treatment device
P gas passage
S air space

1. A membrane electrode assembly (MEA) used for an electrochemical reaction causing gas decomposition, comprising:
a porous base; and
a MEA body portion in which a porous anode, an ion-conductive solid electrolyte, and a porous cathode are stacked,
wherein the anode or the cathode is disposed in contact with a surface of the porous base, and
the porous anode has a porous layer or deposit layer of a metal having catalysis for the gas decomposition.

2. The membrane electrode assembly according to claim 1, wherein the porous base is a cylindrical body; the anode is disposed so as to have a cylindrical form in contact with an outer circumferential surface of the cylindrical body; and the solid electrolyte and the cathode are disposed so as to have cylindrical forms on the anode.

3. The membrane electrode assembly according to claim 1, wherein the porous base is a cylindrical body; the cathode is disposed so as to have a cylindrical form in contact with an inner circumferential surface of the cylindrical body; and the solid electrolyte and the anode are disposed so as to have cylindrical forms on an inner-surface side of the cathode.

4. The membrane electrode assembly according to claim 1, wherein the metal having catalysis is composed of at least one selected from the group consisting of Ni, a Ni—Fe system, a Ni—Co system, a Ni—Cu system, a Ni—Cr system, and a Ni—W system.

5. The membrane electrode assembly according to claim 1, wherein the anode has a thickness of 1 μm or more and 1 mm or less.

6. The membrane electrode assembly according to claim 1, wherein the anode has a thickness of 50 μm or less and the anode does not contain any ion-conductive ceramic.

7. The membrane electrode assembly according to claim 1, wherein the anode contains an ion-conductive ceramic.

8. The membrane electrode assembly according to claim 1, wherein the solid electrolyte has a thickness of 0.7 μm or more and 20 μm or less.

9. The membrane electrode assembly according to claim 1, wherein the solid electrolyte is oxygen-ion conductive or proton conductive.

10. The membrane electrode assembly according to claim 1, wherein the anode, the solid electrolyte, and the cathode are formed by an electrophoretic process or a plating process.

11. The membrane electrode assembly according to claim 1, wherein a conductor having a form that does not degrade porosity is disposed on at least one selected from a surface and another surface of the porous base, a surface of the anode on a side opposite to the solid electrolyte, and a surface of the cathode on a side opposite to the solid electrolyte.

12. A fuel cell comprising the membrane electrode according to claim 1.

13. A gas detoxification apparatus comprising the electrode assembly according to claim 1.

14. A method for producing a membrane electrode assembly (MEA) used for an electrochemical reaction causing gas decomposition, comprising:
a step of preparing a porous base;
a step of forming a multilayer-body MEA in which a porous anode, a solid electrolyte and a porous cathode are stacked on the porous base by an electrophoretic process or a plating process; and
a step of sintering the porous base included in the multilayer-body MEA,
wherein, in the step of forming the multilayer-body MEA, the multilayer-body MEA is formed such that the porous anode or the porous cathode is in contact with a surface of the porous base and the anode is formed so as to include a porous layer or deposit layer of a metal having catalysis for the gas decomposition.

15. The method for producing a membrane electrode assembly according to claim 14, wherein, in the electrophoretic process or the plating process, the anode is formed such that ion-conductive ceramic particles are dispersed in the porous layer or deposit layer composed of Ni or a Ni alloy.

16. The method for producing a membrane electrode assembly according to claim 14, wherein, in the electrophoretic process or the plating process, the anode is formed such that the porous layer or deposit layer composed of Ni or a Ni alloy does not contain any ion-conductive ceramic particles.

17. The method for producing a membrane electrode assembly according to claim 14, wherein the porous base is formed as a cylindrical body; the anode is formed so as to have a cylindrical form in contact with an outer circumferential surface of the cylindrical body, and the solid electrolyte and the cathode are subsequently sequentially formed so as to have cylindrical forms on an outer-surface side of the anode.

18. The method for producing a membrane electrode assembly according to claim 14, wherein the porous base is formed as a cylindrical body; the cathode is formed so as to have a cylindrical form in contact with an inner circumferential surface of the cylindrical body, and the solid electrolyte and the anode are subsequently sequentially formed so as to have cylindrical forms on an inner-surface side of the cathode.
